(19) United States
(12) Patent Application Publication
(10) Pub. No.: US 2008/0084391 A1
(43) Pub. Date: Apr. 10, 2008

(54) Mouse

(76) Inventor: Tong-Hsin Cheng, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/543,977

(22) Filed: Oct. 6, 2006

(51) Int. Cl. G09G 5/08

(52) U.S. Cl. 345/163

(57) ABSTRACT

A mouse is primarily constituted by a housing, an interior of which is provided with a glider which is formed with a default pattern of texture, at a position corresponding to an inner surface of the housing on which is installed with a window, allowing a user to activate the glider to glide in a default area to result in an effect of moving images. The mouse can remove a restriction that a conventional optical mouse must be abutted on a mouse pad or a desktop for operation, can effective reduce a fatigue and sour caused by using the mouse. In particular, as the pattern of texture is completely hidden in the housing, it will not get dirty by sweat or be damaged by foreign objects, thereby greatly improving accuracy of controlling a mouse pointer.

### BACKGROUND OF THE INVENTION

(a) Field of the Invention

The present invention relates to an optical mouse which uses a detection of a movement of images to access information related to a position of a mouse pointer, and more particularly to an optical mouse wherein an image movement mechanism for generating an effect of moving the images is improved to effectively solve issues that a conventional optical mouse must be abutted on a low luster plane such as a mouse pad or a desk for use, which is easy to affect a sensitivity of the mouse pointer and is easier to cause a disorder to a wrist.

(b) Description of the Prior Art

As development of a mouse is continuously towards an extremely precise position and a personalization of shape, the mouse which only serves as an accessory originally has gradually become a main stream of desktop equipment, and therefore is one of indispensable input equipment for computer users. It is called as the mouse, because it can be agile like a mouse and can replace our fingers to do a lot of point-and-click works.

The conventional mouse which is commonly used nowadays is divided into a roller-ball mouse and an optical mouse, wherein the roller-ball mouse uses a movement of a round ball in a disc encoder to reduce a direction and a distance of movement of a mouse pointer (that is, information related to a position of the mouse pointer), and a mechanical joint is located between the roller-ball and a sensor, thereby being easy to affect a sensitivity of the mouse pointer from dusts; and the optical mouse uses a method of detecting a movement of images to access the information related to the position of mouse pointer, which is less affected by an error of mechanical action.

Referring to FIG. 1, a conventional optical mouse includes a housing 10, an interior of which is provided with an optical mechanism assembly 20, and an interface circuit 30, wherein the optical mechanism assembly 20 is further composed of a lighting element 21 for generating light, an image retrieving element 22 for retrieving the images reflected from the light, and mostly an optical lens 23 for enhancing a projection effect of the light; whereas the interface circuit 30 is further composed of a microprocessor 31, and operating switches 32 such as press buttons, or rollers.

For the conventional optical mouse, the light will be projected on an abutting surface (a low luster surface such as a mouse pad or a desktop) at a bottom of the mouse through a window 11 at a bottom of the housing 10, and the images which are reflected from the abutting surface of mouse are received by the image retrieving element 22. The microprocessor 31 will then reduce the images acquired by the image retrieving element 22 into a degree of movement. To be more specific, the image which is retrieved at a certain time point is compared with the image retrieved at a subsequent time point, next the degree of movement is detected, and then, the information related to the position of mouse pointer and signals of the operating switches are transmitted to a computer through the interface circuit.

However, for a conventional method of moving a cursor which is commonly used by the conventional mouse, the entire mouse must be moved towards a corresponding direction of the movement of cursor, so as to achieve a purpose of controlling the cursor under a detection by a motion sensor module (mechanical or optical). Therefore, the conventional mouse is limited to be used only on the mouse pad or desktop. In particular, the optical mouse is further limited to operate on the low luster plane, such that the sensitivity of mouse pointer will not be affected from a too large difference of the reflected images. In other words, most of the computer users must reach their arms to the desktop for operating the mouse. Therefore, as an increase of time spent in operating the mouse, and a gesture in using the mouse for a long time, it will cause a pain to a wrist or a fatigue to muscle, and even cause a disorder to the wrist.

### SUMMARY OF THE INVENTION

Accordingly, the primary object of present invention is to solve issues that a conventional mouse must be abutted on a low luster plane such as a mouse pad or a desktop for use, which is easy to cause a fatigue and sour to an arm, and is disadvantageous to an ergonomic design.

Upon implementing, an interior of a housing of the mouse is primarily provided with an optical mechanism assembly, an interface circuit, and a glider, wherein the glider is provided with a default pattern of texture at a position corresponding to an inner surface of the housing, and the housing of mouse is provided with a window, allowing a user to activate the glider to glide in a default area. Through illuminating the pattern of texture by light in the optical mechanism assembly, and a retrieving of images which are reflected from the pattern of texture by an image retrieving element, a movement of the mouse can be acquired by comparing relative positions of the old and new images.

Accordingly, a restriction that the conventional mouse must be abutted on the mouse pad or desktop for use is removed, the fatigue and sour caused by using the mouse is effectively decreased, and the ergonomic design of the mouse shape can be more facilitated. In particular, as the pattern of texture is completely hidden in an inner side of the housing, it will not get dirty by sweat or be damaged by foreign objects, thereby greatly improving accuracy of controlling the mouse pointer.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of a conventional mouse structure.

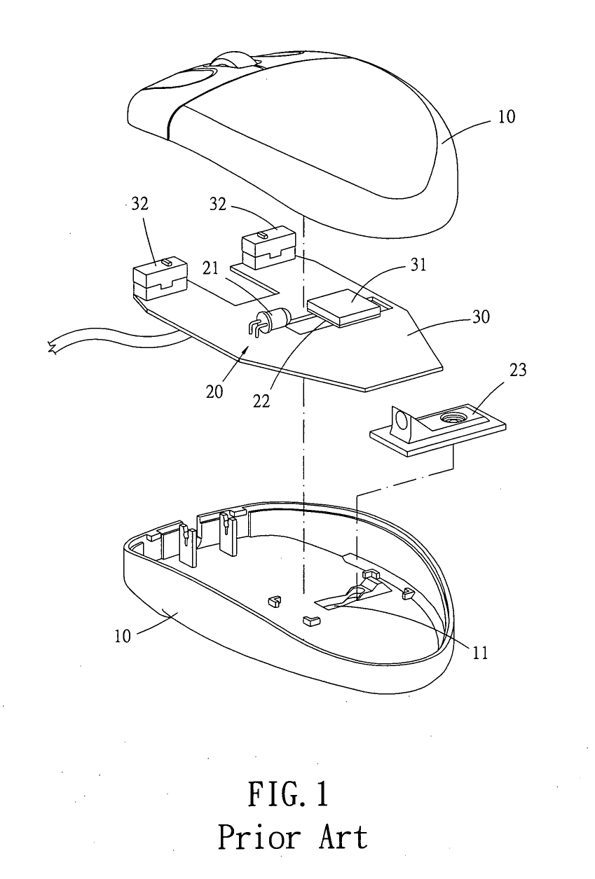

FIG. 2 shows a perspective view of a mouse of the present invention.

FIG. 3 shows an exploded view of a mouse structure of the present invention.

FIG. 4 shows a schematic view of a motion of a mouse of the present invention.

FIG. 5 shows a schematic view of a motion of another embodiment of mouse of the present invention.

### DETAILED DESCRIPTION OF THE PREFERRED EMBODIMENTS

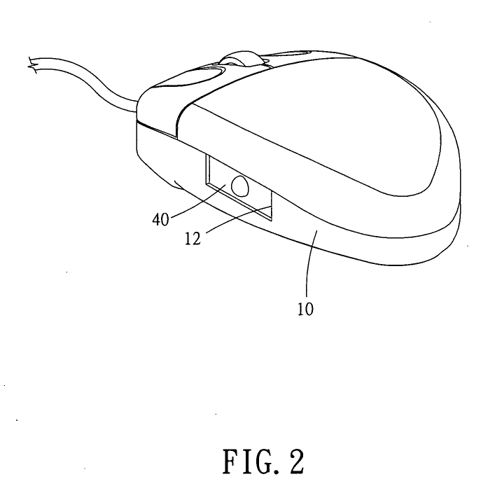

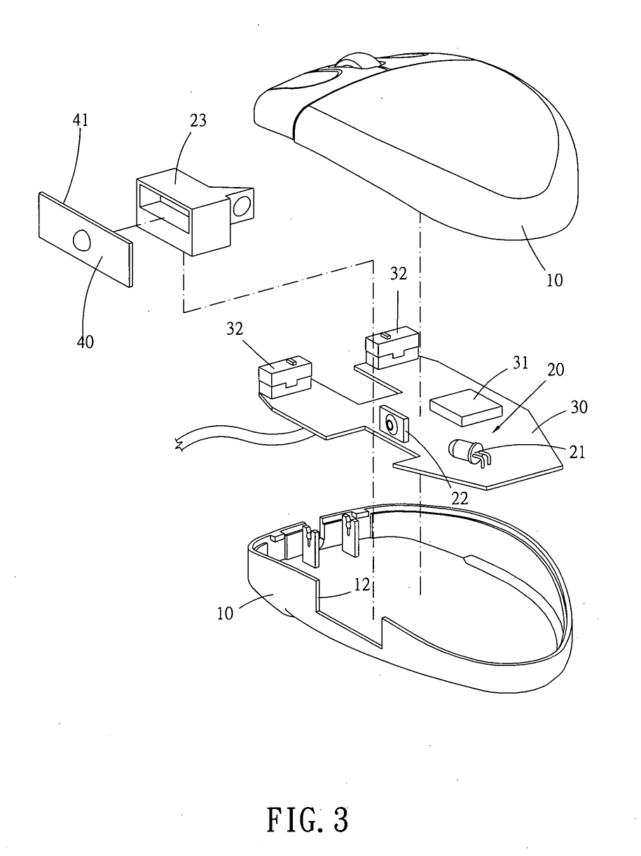

A mouse of the present invention uses primarily a mechanism of detecting a movement of images to access information related to a position of a mouse pointer. Referring to FIG. 2 and FIG. 3, a basic structure of an entire mouse includes a housing 10, an interior of which is provided with an optical mechanism assembly 20, an interface circuit 30, and a glider 40.

The optical mechanism assembly 20 is used to generate an illuminating light, and is used to receive images reflected by the light. Therefore, the optical mechanism assembly 20 is primarily composed of a lighting element 21 for generating the light, and an image retrieving element 22 for retrieving the images which are reflected by the light. Of course, it can also be configured with an optical lens 23 to enhance a projection effect of the light. Whereas the interface circuit 30 is used to transmit the information related to the position of mouse pointer and signals of operating switches to a device linked to the mouse; therefore, it should include a microprocessor 31 which is used to convert the images acquired by the image retrieving unit 22 into a degree of movement, and the operating switches 32 such as press buttons, rollers.

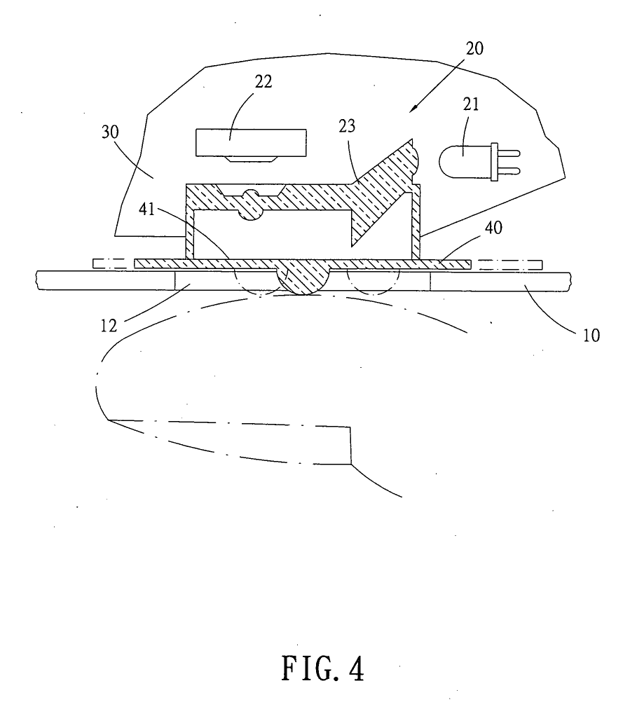

The essential concept of present invention lies in the design of glider 40. Through the glider 40, the optical mouse itself will be provided with an image-moving mechanism for generating an effect of moving the images, wherein the glider 40 is provided with a default pattern of texture 41, at a position corresponding to an inner surface of the housing 10, and the pattern of texture 41 can be made by molding, etching, printing, or sticking. The related components as described above are installed in a mechanical structure which is constituted by the housing 10 on which is provided with a window 12, as shown in FIG. 4, allowing a user to activate the glider 40 to glide in a default area. In addition, the pattern of texture 41 of the glider 40 is illuminated by the light resulting from the lighting element 21 in the optical mechanism assembly 20, and the images reflected from the pattern of texture 41 are retrieved by the image retrieving element 22, such that the information of mouse movement can be acquired by comparing relative positions of the old and new images.

Accordingly, the user can simply push the glider 40 to control a direction and a distance of movement of the mouse, which changes an operational mode of the conventional mouse that the entire mouse must be pushed to move, thereby completely removing the restriction that the conventional mouse should be abutted on the low luster plane such as the mouse pad or the desktop, and even allowing the user to operate the mouse with a gesture that an arm is easily placed. Of course, an ergonomics design can be facilitated, or the mouse can be directly built on a notebook computer, to increase adaptability and convenience in using the notebook computer.

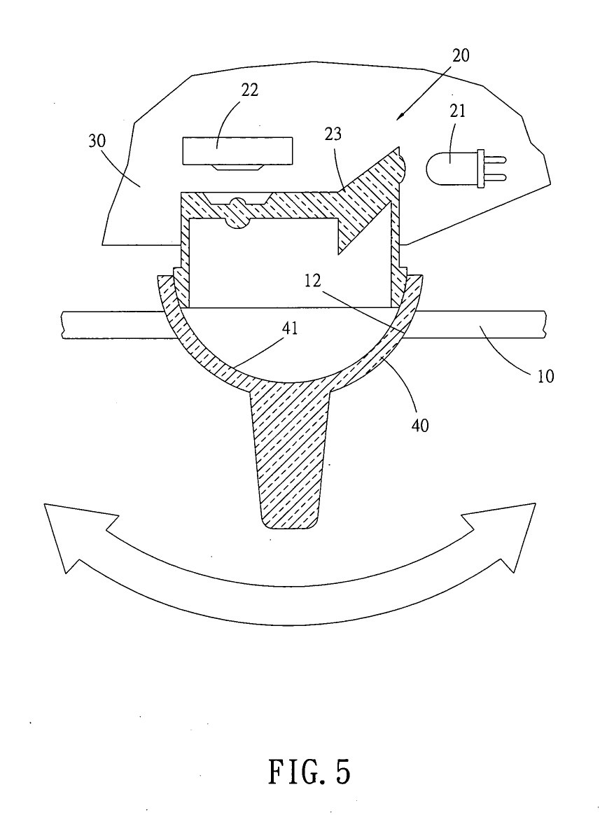

Upon implementing, the glider 40 can be glided on a plane, as shown in FIG. 4, or can be glided on a spherical surface, as shown in FIG. 5, which enables the mouse to be more suitable to game software. No matter what kind of shape of the mouse of present invention is, the primary characteristic is to hide the pattern of texture 41 which is used to generate the reflected images in an inner side of the housing 10, without getting dirty by sweat or being damaged by foreign objects, thereby greatly improving accuracy of controlling the mouse pointer.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A mouse comprising a housing, an interior of which is provided with an optical mechanism assembly and an interface circuit, wherein an interior of the housing is additionally provided with a glider having a default pattern of texture, at a position corresponding to an inner surface of the housing on which is installed with a window, allowing a user to activate the glider to glide in a default area, so as to form an effect of moving images.

2. The mouse according to claim 1, wherein the optical mechanism assembly is constituted by a lighting element which is used to generate light, and an image retrieving element which is used to retrieve the images reflected by the light.

3. The mouse according to claim 1, wherein the optical mechanism assembly is constituted by a lighting element which is used to generate light, an image retrieving element which is used to retrieve the images reflected by the light, and an optical lens which is used to enhance a projection effect of the light.

4. The mouse according to claim 1, wherein the interface circuit is further composed of a microprocessor and related operating switches.

5. The mouse according to claim 1, wherein the pattern of texture of glider is made by molding.

6. The mouse according to claim 1, wherein the pattern of texture of glider is made by etching.

7. The mouse according to claim 1, wherein the pattern of texture of glider is made by printing.

8. The mouse according to claim 1, wherein the pattern of texture of glider is made by sticking.
